(19) United States
(12) Patent Application Publication
(10) Pub. No.: US 2026/0197050 A1
(43) Pub. Date: Jul. 9, 2026

(54) UPLINK CONTROL INFORMATION FALSE PAYLOAD DECODING MITIGATION

(71) Applicant: Dell Products L.P., Round Rock, TX (US)

(72) Inventors: Eran Goldstein, Montreal (CA); Ravi Sharma, Cupertino, CA (US); Manbir Kaur, Brampton (CA); Jayaram Venguduswamy Srinivasan, Kanata (CA)

(21) Appl. No.: 19/010,588

(22) Filed: Jan. 6, 2025

(51) Int. Cl. H04B 7/06; H04B 7/0456

(52) U.S. Cl. CPC H04B 7/0626; H04B 7/0456

(57) ABSTRACT

Distributed unit monitoring of user equipment transmitter power degradation (e.g., using a computerized tool), is enabled. For example, a system can comprise at least one processor and at least one memory that stores executable instructions that, when executed by the processor, facilitate performance of operations. The operations can comprise determining an estimated coherence time for a communicative connection between a user equipment and a base station, for each channel state information indication of a group of channel state information indications sent from the user equipment to the base station, determining a difference between a current channel state information indication indicative of a current channel state and a previous channel state information indication indicative of a previous channel state, and in response to a determination that the difference exceeds a defined difference threshold determined based on the estimated coherence time, flagging the current channel state information indication as invalid.

### BACKGROUND

User equipment (UE) are typically configured to periodically send their respective channel state information. Such channel state information may include, for instance, rank indicator (RI), precoding matrix indicator (PMI), and/or channel quality indicator (CQI), which are indicators that help a cell (e.g., a base station) configure the optimal number of layers in an optimal precoding matrix, and the optimal coding rate/modulation order. The periodicity is commonly set to ensure that such that updates arrive at the cell frequently enough in order that the cell will be up to date. A channel state information (CSI) report is usually carried on robust channels with low coding rate to ensure high probability of decoding.

Even though low BLER is expected for CSI reports, cases of decoding error can occur as frequently as 1% of the time. In the fifth generation (5G) standard, the CSI report is carried over the control channel (PUCCH) with payload size of less than 12 bits having no cyclic redundancy check (CRC) protection, and therefore there is no corresponding error-detecting code mechanism. Even with payload sizes of 12-19 bits, the standard employs a CRC of 6 bits, and therefore has a relatively high rate of false CRC indications. A cell using a corrupted CSI payload, with incorrect RI, PMI, or CQI results in degraded performance, repeated downlink (DL) retransmissions, increased latency, degraded spectral efficiency, and increased power consumption.

The above-described background relating to CSI payload is merely intended to provide a contextual overview of some current issues and is not intended to be exhaustive. Other contextual information may become further apparent upon review of the following detailed description.

### BRIEF DESCRIPTION OF DRAWINGS

FIG. 1 is a block diagram of a non-limiting example system in accordance with one or more example embodiments described herein.

FIG. 2 is a block diagram of a non-limiting example system in accordance with one or more example embodiments described herein.

FIG. 3 is a chart of example CSI reporting in accordance with one or more example embodiments described herein.

FIG. 4 is a chart of example CQI reporting in accordance with one or more example embodiments described herein.

FIG. 5 is a flowchart for a process associated with uplink control information false payload decoding mitigation in accordance with one or more example embodiments described herein.

FIG. 6 is a block flow diagram for a process associated with uplink control information false payload decoding mitigation in accordance with one or more example embodiments described herein.

FIG. 7 is a block flow diagram for a process associated with uplink control information false payload decoding mitigation in accordance with one or more example embodiments described herein.

FIG. 8 is a block flow diagram for a process associated with uplink control information false payload decoding mitigation in accordance with one or more example embodiments described herein.

FIG. 9 is an example, non-limiting computing environment in which one or more embodiments described herein can be implemented.

FIG. 10 is an example, non-limiting networking environment in which one or more embodiments described herein can be implemented.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

As alluded to above, uplink control information false payload decoding mitigation can be improved in various ways, and various embodiments are described herein to this end and/or other ends.

According to an example embodiment, a system can comprise at least one processor, and at least one memory that stores executable instructions that, when executed by the at least one processor, facilitate performance of operations, comprising determining an estimated coherence time for a communicative connection between a user equipment and a base station, for each channel state information indication of a group of channel state information indications sent from the user equipment to the base station, determining a difference between a current channel state information indication indicative of a current channel state and a previous channel state information indication indicative of a previous channel state, and in response to a determination that the difference exceeds a defined difference threshold determined based on the estimated coherence time, flagging the current channel state information indication as invalid.

In one or more example embodiments, the estimated coherence time can be further determined based on a channel doppler spread of an uplink channel of the communicative connection. In one or more example embodiments, the estimated coherence time can be further determined based on a rate of change of channel state information indications of the group of channel state information indications. In one or more example embodiments, the estimated coherence time can be further determined based on a rate of change of sounding reference signals of a group of sounding reference signals applicable to the communicative connection.

In one or more example embodiments, the difference between the current channel state information indication and the previous channel state information indication can be a first difference, and the current channel state information indication can be flagged as invalid further based on a comparison of the first difference to a second difference between a current sounding reference signal to a previous sounding reference signal.

In one or more example embodiments, the difference between the current channel state information indication and the previous channel state information indication can be determined based on an individual field in response to a determination that a current rank indicator associated with the current channel state information indication and a previous rank indicator associated with the previous channel state information indication are equal or substantially equal. In this regard, the individual field can comprise a precoding matrix indicator, a rank indicator, or a channel quality indicator.

In one or more example embodiments, the difference between the current channel state information indication and the previous channel state information indication can be determined based on requested overall spectral efficiency in response to a determination that a current rank indicator associated with the current channel state information indication and a previous rank indicator associated with the previous channel state information indication are not equal or substantially equal.

In one or more example embodiments, the above operations can further comprise, in response to the current channel state information indication being flagged as invalid, utilizing the previous channel state information indication instead of the current channel state information indication for a base station configuration.

In one or more example embodiments, the above operations can further comprise, in response to the current channel state information indication being flagged as invalid, rechecking the current channel state information indication. In this regard, the above operations can further comprise, in response to the rechecking the current channel state information indication resulting in the current channel state information indication being determined not to be invalid, removing the flagging.

In one or more example embodiments, the defined difference threshold can be determined based on prior simulations of base station configurations.

In another example embodiment, a non-transitory machine-readable medium can comprise executable instructions that, when executed by at least one processor, facilitate performance of operations, comprising determining an estimated coherence time for a communicative connection between a user device and network equipment, for each channel state information indication of a group of channel state information indications sent from the user device to the network equipment, determining a difference between a current channel state information indication and a previous channel state information indication, and in response to a determination that the difference exceeds a defined difference threshold determined based on the estimated coherence time, determining that the current channel state information indication is incorrect.

In one or more example embodiments, the estimated coherence time can be further determined based on a channel doppler spread of an uplink channel of the communicative connection. In one or more example embodiments, the estimated coherence time can be further determined based on a rate of change of channel state information indications of the group of channel state information indications. In one or more example embodiments, the estimated coherence time can be further determined based on a rate of change of sounding reference signals of a group of sounding reference signals applicable to the communicative connection.

In one or more example embodiments, the difference between the current channel state information indication and the previous channel state information indication can be a first difference, and the current channel state information indication can be determined to be incorrect further based on a comparison of the first difference to a second difference between a current sounding reference signal to a previous sounding reference signal.

In yet another example embodiment, a method can comprise determining, by a device comprising at least one processor, an estimated coherence time for a communicative connection between a mobile device and an access point, for each channel state information indication of a group of channel state information indications sent from the mobile device to the access point, determining, by the device, a difference between a current channel state information indication and a previous channel state information indication, and in response to a determination that the difference exceeds a defined difference threshold determined based on the estimated coherence time, tagging, by the device, the current channel state information indication as inaccurate.

In one or more example embodiments, the difference between the current channel state information indication and the previous channel state information indication can be determined based on an individual field in response to a determination that a current rank indicator associated with the current channel state information indication and a previous rank indicator associated with the previous channel state information indication are equal or substantially equal. In this regard, the individual field can comprise a precoding matrix indicator, a rank indicator, or a channel quality indicator.

In various example embodiments described herein, a CSI payload can be filtered (e.g., by a system herein) for unexpected, large changes in indicators. In various example embodiments, the cell (e.g., a base station) can handle the case of suspicious payload, due to an unexpected large change in the indicators, in different ways. For instance, the cell (e.g., base station) can request an aperiodic CSI to repeat the payload from the UE side, discard the payload and use previous one, utilize sounding reference signal (SRS) indicators instead, or utilize a gradual change.

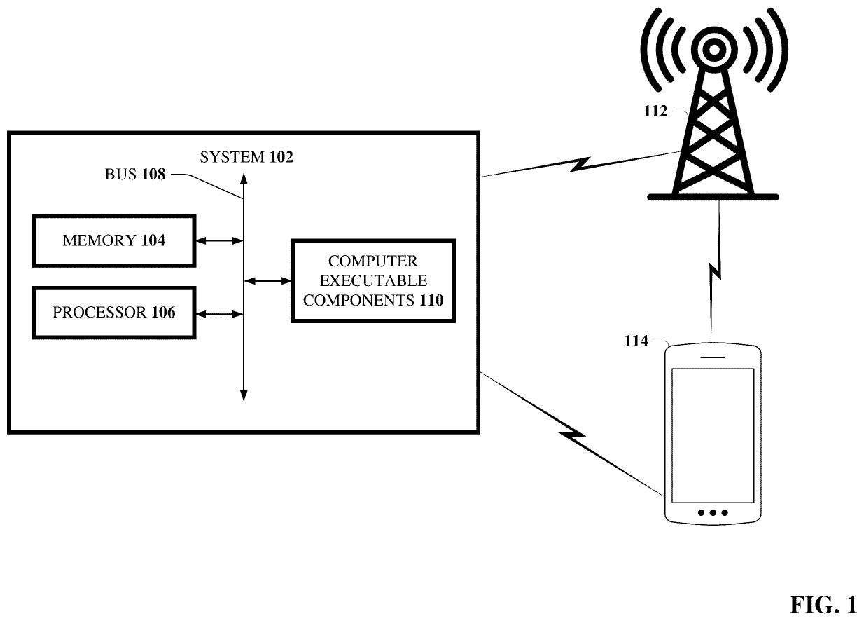

Turning now to FIG. 1, there is illustrated an example, non-limiting system 102 in accordance with one or more example embodiments herein. System 102 can comprise a computerized tool, which can be configured to perform various operations relating to uplink control information false payload decoding mitigation. The system 102 can comprise one or more of a variety of components, such as memory 104, processor 106, bus 108, and/or computer executable components 110. In various embodiments, one or more of the memory 104, processor 106, bus 108, and/or computer executable components 110 can be communicatively or operably coupled (e.g., over a bus or wireless network) to one another to perform one or more functions of the system 102. In various example embodiments, the system 102 can comprise and/or be communicatively coupled to base station 112 and/or UE 114.

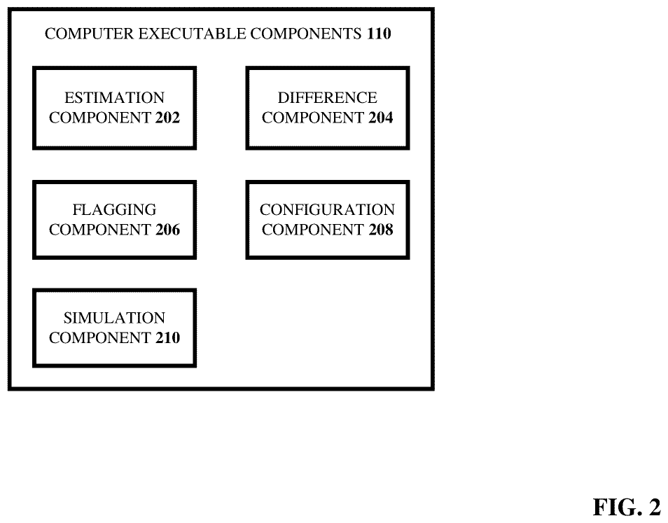

FIG. 2 illustrates a block diagram of example, non-limiting computer executable components 110 that can facilitate uplink control information false payload decoding mitigation in accordance with one or more embodiments described herein. Repetitive description of like elements employed in other embodiments described herein is omitted for sake of brevity. As shown in FIG. 2, the one or more computer executable components 110 can comprise estimation component 202, difference component 204, flagging component 206, configuration component 208, and/or simulation component 210.

In various example embodiments, the system 102 can periodically determine an estimated coherence time of the UE 114 and maintain an up-to-date estimate of the coherence time. In this regard, the estimation component 202 can determine an estimated coherence time for a communicative connection between a user equipment (e.g., UE 114) (e.g., or user device or mobile device) and a base station (e.g., base station 112) (e.g., or network equipment or access point such as a gNodeB). In one or more example embodiments, the estimated coherence time can be determined (e.g., via the estimation component 202) based on a channel doppler spread of an uplink channel of the communicative connection between the UE 114 and the base station 112. In further example embodiments, the estimated coherence time can be determined (e.g., via the estimation component 202) based on a rate of change of channel state information indications of the group of channel state information indications. In additional example embodiments, the estimated coherence time can be determined (e.g., via the estimation component 202) based on a rate of change of sounding reference signals of a group of sounding reference signals applicable to the communicative connection between the UE 114 and the base station 112.

In various example embodiments, the difference component 204 can, for each channel state information indication of a group of channel state information indications sent from the user equipment (e.g., UE 114) to the base station (e.g., base station 112), determine a difference between a current channel state information indication indicative of a current channel state and a previous channel state information indication indicative of a previous channel state. In this regard, the difference component 204 can compare the two sets of CSI metrics, for instance, to analyze how the wireless channel has changed over time.

In one or more example embodiments, for each CSI indication sent by the UE 114, the system 102 can measure the difference of the current indicators compared to the previously sent indicators. The foregoing can be achieved, for instance, by using the following formula (in the cases in which RI does change from the previous report):

$$Δ CSI = α * {\vert {CQI}_{prv} - {CQI}_{cur} \vert}^{2} + β * {\vert {PM}_{prv} - {PM}_{cur} \vert}^{2} \qquad Equation ( 1 )$$

In this regard, the difference between the current channel state information indication and the previous channel state information indication can be determined (e.g., via the difference component 204) based on an individual field in response to a determination that a current rank indicator associated with the current channel state information indication and a previous rank indicator associated with the previous channel state information indication are equal or substantially equal. Further in this regard, the individual field can comprise a precoding matrix indicator, a rank indicator, or a channel quality indicator (e.g., associated with the communicative connection between the UE 114 and the base station 112).

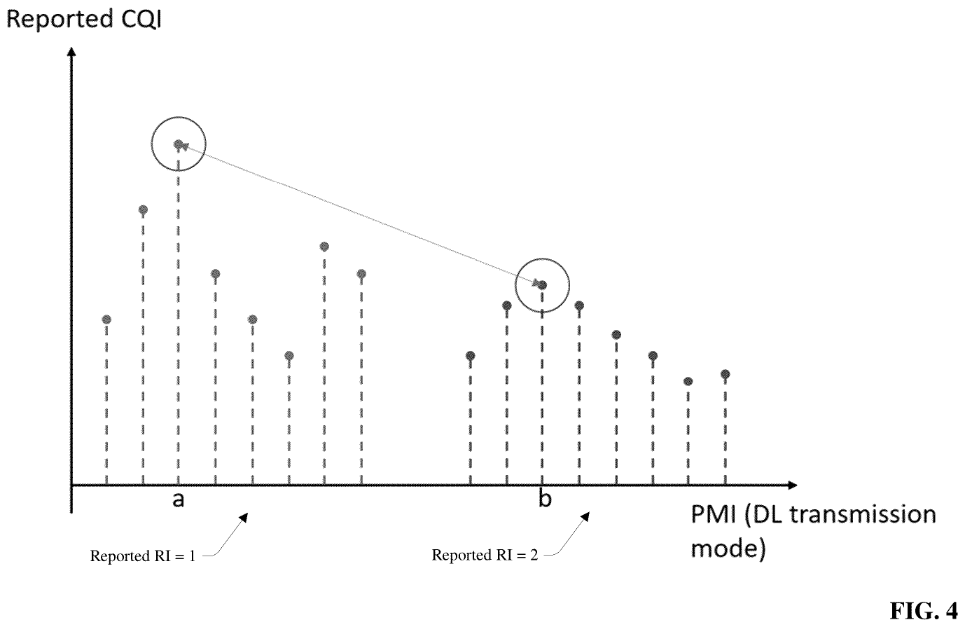

In the cases in which the RI has changed, the difference of the current indicators compared to the previously sent ones can be measured (e.g., via the system 102) not over the individual fields (e.g., PMI/RI/CQI), but rather over the requested overall spectral efficiency. In its report, the UE 114 can evaluate the achievable DL spectral efficiency (see, e.g., FIG. 4). If a different RI has become more spectrally efficient than the previously requested RI, a sudden large change in PMI, RI, and/or CQI could occur, however, the achievable spectral efficiency will not change significantly.

$$Δ CSI = γ * {\vert {SE}_{prv} ( {CQI}_{prv} , {PM}_{prv} , {RI}_{prv} ) - {SE}_{prv} ( {CQI}_{cur} , {PM}_{cur} , {RI}_{cur} ) \vert}^{2} \qquad Equation ( 2 )$$

where:
ΔCSI represents quantity of change between current and previous CSI report.
CQIₚᵣᵥ signifies previous CQI report.
CQI_{cur} signifies current CQI report.
PMₚᵣᵥ signifies previous precoding matrix report (not the index—the actual matrix).
PM_{cur} signifies current precoding matrix report (not the index—the actual matrix).
RIₚᵣᵥ signifies previous rank report.
RI_{cur} signifies current rank report.
α, β, γ signify the weight coefficient of each component.

It is noted that the values (e.g., coefficients) herein can be optimized (e.g., via the system 102). It is additionally noted that, in general, the coefficients can be a function of the RI. In this regard, the PMI coefficient β is not expected to significantly change in scenarios in which only one layer is requested (RI=1), as the optimal beam direction tends to evolve slowly. However, when more layers are requested, the optimal beam direction can flip rapidly, as there are several optimal options.

The matrix difference component (|PMₚᵣᵥ−PM_{cur}|²) can be executed (e.g., via the system 102), for instance, when the corresponding matrices have the same rank. Otherwise, this matrix difference component can be omitted from Equation (2), or the distance of each row of the first matrix can be calculated to all rows of the second matrix. It is noted that, in further embodiments, other non-negative distance functions can be utilized.

In this regard, in one or more example embodiments, the difference between the current channel state information indication and the previous channel state information indication can be determined (e.g., via the difference component 204) based on requested overall spectral efficiency in response to a determination that a current rank indicator associated with the current channel state information indication and a previous rank indicator associated with the previous channel state information indication are not equal or substantially equal.

In various example embodiments, the system 102 can compare the ΔCSI to the threshold value which can be a function of the estimated coherence time:

$$Δ CSI > TH ( \frac{Δ T}{C} ) \qquad Equation ( 3 )$$

where:

TH signifies the threshold value above which the CSI is flagged as suspicious (e.g., invalid).

C signifies a measurement of the channel's coherence time.

The threshold function TH(x) can comprise a non-negative rising function of x. A function for calculating the threshold function can comprise:

$$TH ( x ) = {ax}^{2} + bx + c \qquad Equation ( 4 )$$

In various example embodiments, the coefficients a, b, and c can be optimized through simulations. In this regard, in one or more example embodiments, the defined difference threshold can be determined (e.g., via the simulation component 210) based on prior simulations of base station (e.g., base station 112) configurations.

In this regard, in various example embodiments, the flagging component 206 can, in response to a determination (e.g., via the difference component 204) that the difference exceeds a defined difference threshold determined based on the estimated coherence time, flag the current channel state information indication as invalid.

If a CSI is flagged (e.g., via the flagging component 206) as suspicious (e.g., invalid), another level of filtering can be performed by the system 102, which can comprise a comparison (e.g., via the system 102) with the latest equivalent change given by the SRS measurement:

$$Δ CSI < δ * Δ {SRS}_{CSI} + θ \qquad Equation ( 5 )$$

where:
ΔSRS_{CSI} is a quantity of the CSI difference based on the SRS measurement. δ, θ signify weight coefficients which are left for optimization.

In a case in which ΔCSI is smaller than the change expected, according to the SRS measurement, the suspicious flag can be removed (e.g., via the flagging component 206).

In one or more example embodiments, the difference between the current channel state information indication and the previous channel state information indication can be a first difference. In this regard, the current channel state information indication can be flagged (e.g., via the flagging component 206) as invalid further based on a comparison of the first difference to a second difference between a current sounding reference signal to a previous sounding reference signal.

In various example embodiments, the configuration component 208 can, in response to the current channel state information indication being flagged (e.g., via the flagging component 206) as invalid, utilize the previous channel state information indication instead of the current channel state information indication for a base station (e.g., base station 112) configuration.

In various example embodiments, the system 102 can, in response to the current channel state information indication being flagged (e.g., via the flagging component 206) as invalid, recheck the current channel state information indication. In this regard, the flagging component 206 can, in response to the rechecking of the current channel state information indication resulting in the current channel state information indication being determined not to be invalid, remove the flagging.

It is noted that the system 102 can perform one or more of the actions, for instance, towards a CSI flagged as suspicious (e.g., invalid): (1) if deemed false, the system 102 can ignore the CSI report and use instead previous CSI measurements; or (2) the system 102 can request an additional aperiodic CSI report. If a similar indication is reported again, the suspicious flag can be removed (e.g., via flagging component 206), and the CSI would be utilized by the system 102.

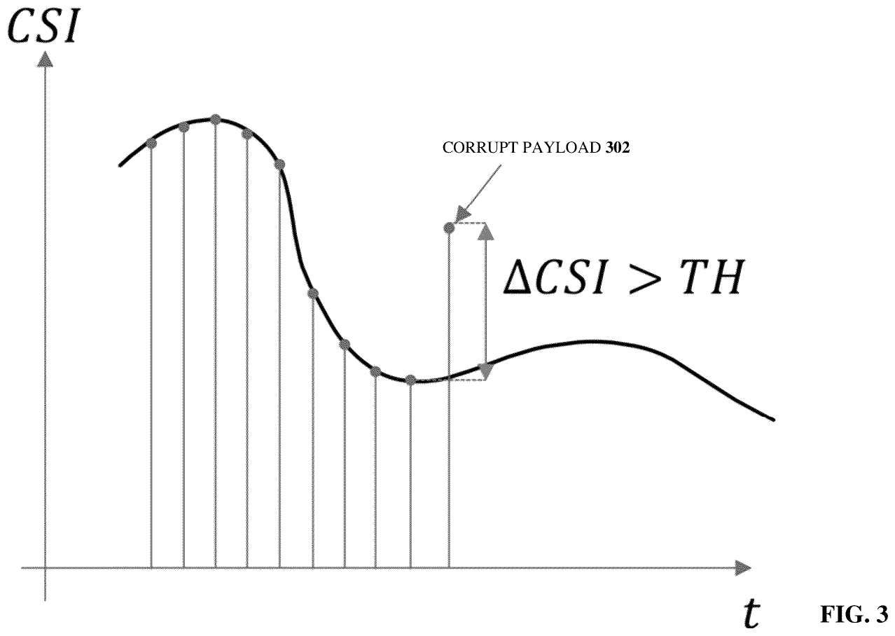

FIG. 3 is a chart of example CSI reporting in accordance with one or more example embodiments described herein. In FIG. 3, each dot represents a CSI report described herein. It is noted that, in one or more example embodiments, CSI reports herein can comprise multidimensional CSI reports. In this regard, FIG. 3 (which shows only one dimension (y-axis)) symbolically illustrates differences (in one example dimension) among CSI reports herein. In FIG. 3, the decoding of last CSI report (e.g., corrupt payload 302) is corrupt and is thus far from the previous report. FIG. 4 is a chart of example CQI reporting in accordance with one or more example embodiments described herein. In various example embodiments, a UE herein (e.g., UE 114) can examine downlink codebook defined transmission modes, and can select the one that is determined to provide the highest spectrum efficiency while maintaining a defined threshold block error rate (BLER) (e.g., 10%). In FIG. 4, the CQI of the best two-layer option (RI=2) is lower than the best one-layer option (RI=1). This is expected, for instance, as with RI=2, the DL transmission power is divided between two layers. The lower CQI indicates that a lower modulation and coding scheme (MCS) of bits is achievable-lower spectral efficiency (SE) per layer. However, considering that two layers doubles the SE, the UE would still switch to report the two layers option as the total spectral efficiency. In FIG. 4, the UE has to select between option a (best RI=1) and option b (best RI=2). If option b becomes more spectrally efficient (e.g., under the BLER restrictions), a large change in CQI and PMI is expected, but not in the spectral efficiency.

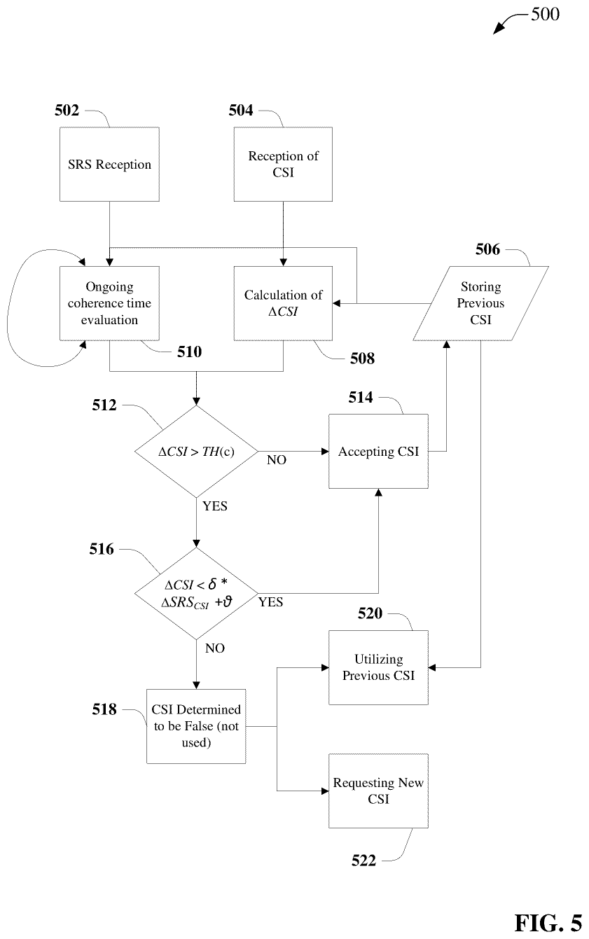

FIG. 5 is a flowchart for a process 500 associated with uplink control information false payload decoding mitigation in accordance with one or more example embodiments described herein. At 502, the system 102 can receive SRS indicators (e.g., via the base station 112 and/or UE 114). At 504, the system 102 can receive current CSI indications (e.g., via the base station 112 and/or UE 114). At 516, previous channel state information indications can be stored (e.g., via the system 102 to a memory 104). At 508, ΔCSI can be calculated (e.g., via the system 102), for instance, using the equations previously described herein. At 510, ongoing coherence time evaluation can be performed (e.g., via the system 102). At 512, if ΔCSI is greater than TH(c) (YES at 512), the process 500 can proceed to 516. If at 512, ΔCSI is not greater than TH (c) (NO at 512), the process 500 can proceed to 514. At 514, the CSI is accepted (not flagged as invalid) by the system 102 (e.g., via the flagging component 206). At 516, if ΔCSI is less than δ*ΔSRS_{CSI}+0 (YES at 516), the process can proceed to 514. If at 516, ΔCSI is not less than δ*ΔSRS_{CSI} +θ (NO at 516), the process can proceed to 518. At 518, the CSI is determined (e.g., via the system 102) to be false (e.g., invalid), and is thus not utilized by the system 102. At 520, a previous CSI can instead be utilized, while at 522 a new CSI can be requested by the system 102.

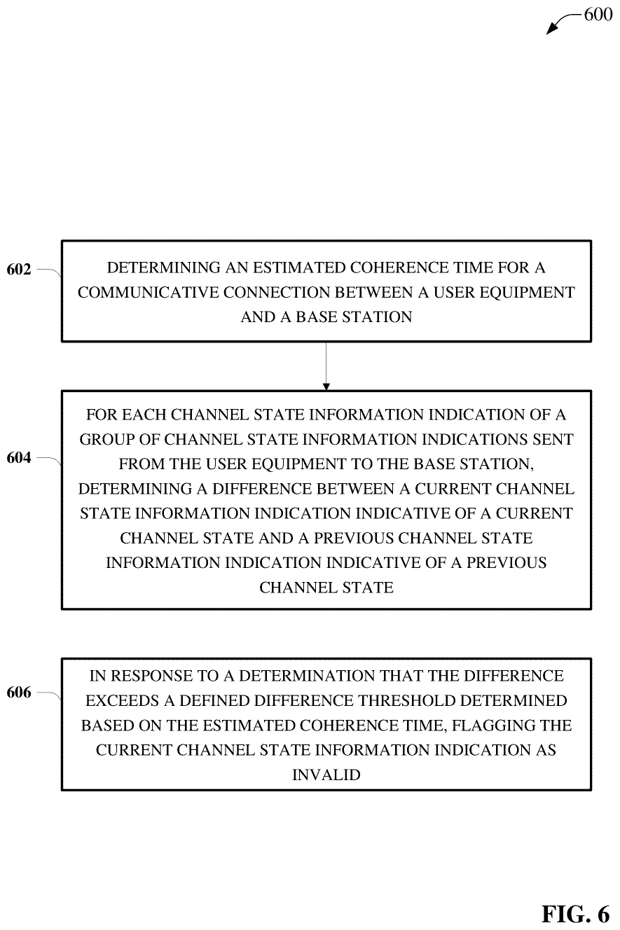

FIG. 6 illustrates a block flow diagram for a process 600 associated with uplink control information false payload decoding mitigation in accordance with one or more embodiments described herein. At 602, the process 600 can comprise determining (e.g., via the estimation component 202) an estimated coherence time for a communicative connection between a user equipment (e.g., UE 114) and a base station (e.g., base station 112). At 604, the process 600 can comprise, for each channel state information indication of a group of channel state information indications sent from the user equipment (e.g., UE 114) to the base station (e.g., base station 112), determining (e.g., via the difference component 204) a difference between a current channel state information indication indicative of a current channel state and a previous channel state information indication indicative of a previous channel state. At 606, the process 600 can comprise, in response to a determination (e.g., via the difference component 204) that the difference exceeds a defined difference threshold determined based on the estimated coherence time, flagging (e.g., via the flagging component 206) the current channel state information indication as invalid.

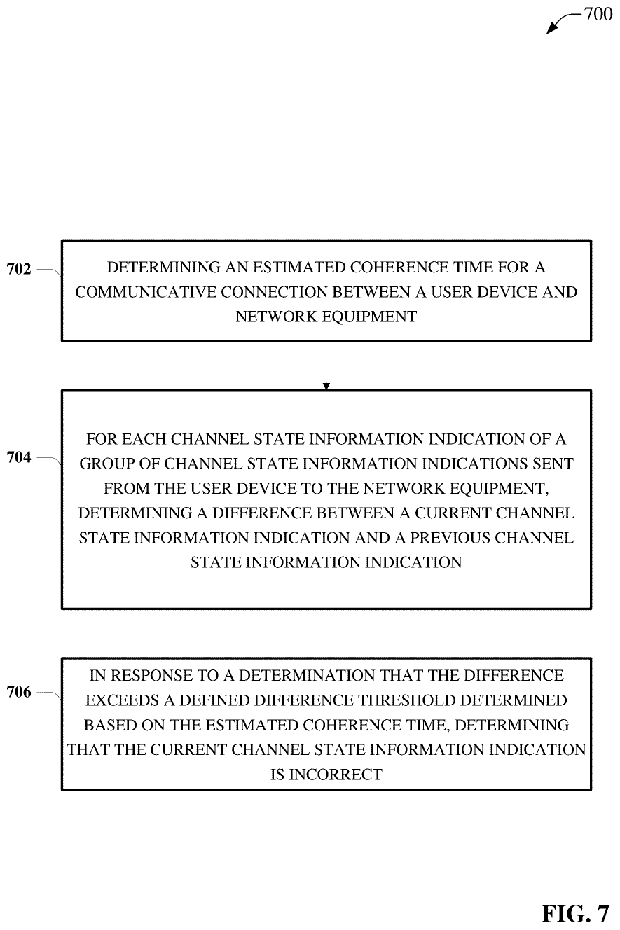

FIG. 7 illustrates a block flow diagram for a process 700 associated with uplink control information false payload decoding mitigation in accordance with one or more embodiments described herein. At 702, the process 700 can comprise determining (e.g., via the estimation component 202) an estimated coherence time for a communicative connection between a user device (e.g., UE 114) and network equipment (e.g., base station 112). At 704, the process 700 can comprise, for each channel state information indication of a group of channel state information indications sent from the user device (e.g., UE 114) to the network equipment (e.g., base station 112), determining (e.g., via the difference component 204) a difference between a current channel state information indication and a previous channel state information indication. At 706, the process 700 can comprise, in response to a determination (e.g., via the difference component 204) that the difference exceeds a defined difference threshold determined based on the estimated coherence time, determining (e.g., via the flagging component 206) that the current channel state information indication is incorrect.

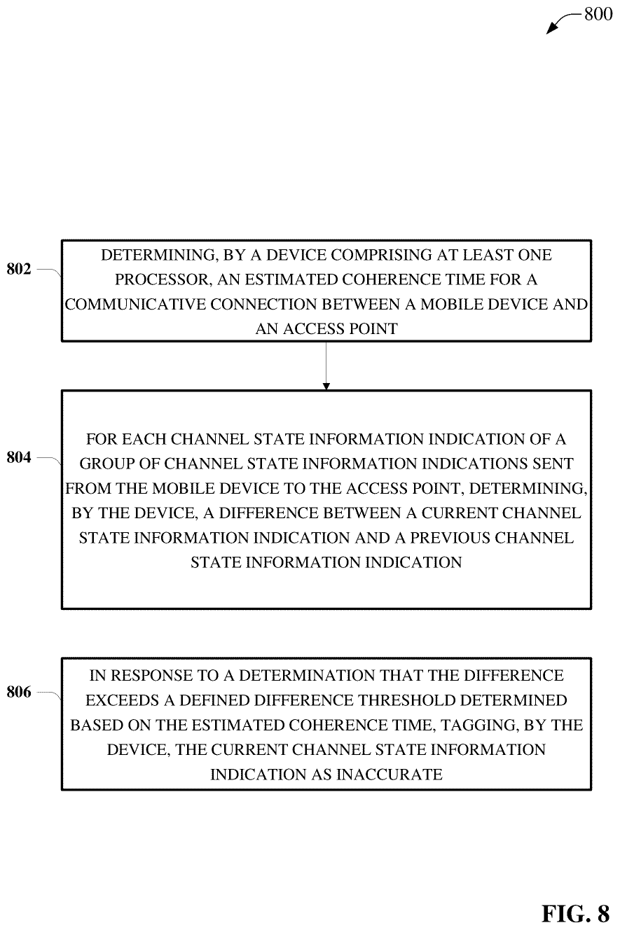

FIG. 8 illustrates a block flow diagram for a process 800 associated with uplink control information false payload decoding mitigation in accordance with one or more embodiments described herein. At 802, the process 800 can comprise determining (e.g., via the estimation component 202), by a device (e.g., system 102) comprising at least one processor (e.g., processor 106), an estimated coherence time for a communicative connection between a mobile device (e.g., UE 114) and an access point (e.g., base station 112). At 804, the process 800 can comprise, for each channel state information indication of a group of channel state information indications sent from the mobile device (e.g., UE 114) to the access point (e.g., base station 112), determining (e.g., via the difference component 204), by the device (e.g., system 102), a difference between a current channel state information indication and a previous channel state information indication. At 806, the process 800 can comprise, in response to a determination (e.g., via the difference component 204) that the difference exceeds a defined difference threshold determined based on the estimated coherence time, tagging (e.g., via the flagging component 206), by the device (e.g., system 102), the current channel state information indication as inaccurate.

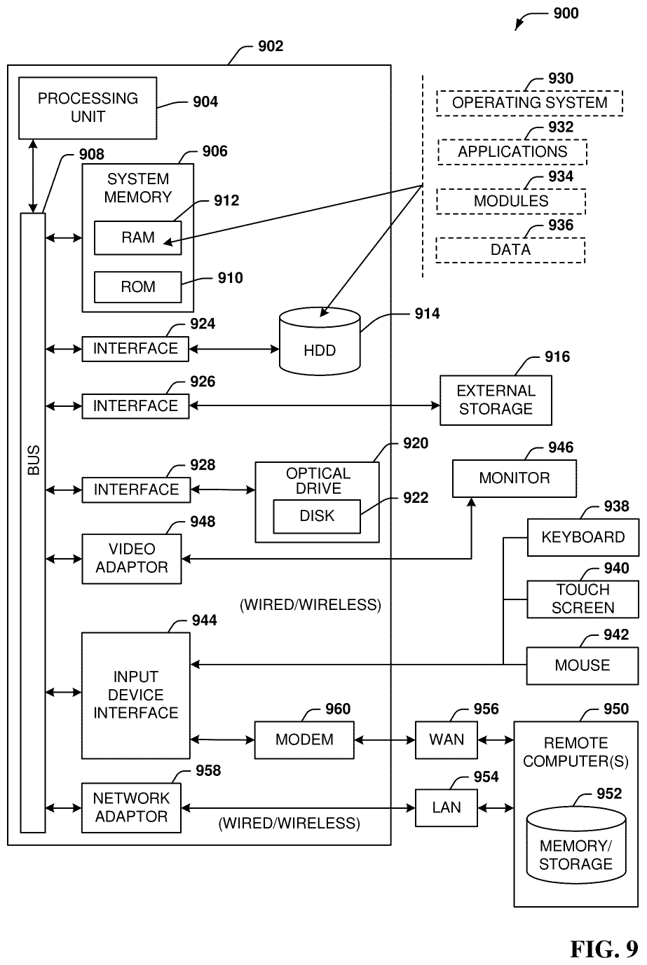

In order to provide additional context for various embodiments described herein, FIG. 9 and the following discussion are intended to provide a brief, general description of a suitable computing environment 900 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared, and other wireless media.

With reference again to FIG. 9, the example environment 900 for implementing various embodiments of the aspects described herein includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes ROM 910 and RAM 912. A basic input/output system (BIOS) can be stored in a non-volatile memory such as ROM, erasable programmable read only memory (EPROM), EEPROM, which BIOS contains the basic routines that help to transfer information between elements within the computer 902, such as during startup. The RAM 912 can also include a high-speed RAM such as static RAM for caching data.

The computer 902 further includes an internal hard disk drive (HDD) 914 (e.g., EIDE, SATA), one or more external storage devices 916 (e.g., a magnetic floppy disk drive (FDD) 916, a memory stick or flash drive reader, a memory card reader, etc.) and an optical disk drive 920 (e.g., which can read or write from a disk 922, such as a CD-ROM disc, a DVD, a BD, etc.). While the internal HDD 914 is illustrated as located within the computer 902, the internal HDD 914 can also be configured for external use in a suitable chassis (not shown). Additionally, while not shown in environment 900, a solid-state drive (SSD) could be used in addition to, or in place of, an HDD 914. The HDD 914, external storage device(s) 916 and optical disk drive 920 can be connected to the system bus 908 by an HDD interface 924, an external storage interface 926 and an optical drive interface 928, respectively. The interface 924 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 912, including an operating system 930, one or more application programs 932, other program modules 934 and program data 936. All or portions of the operating system, applications, modules, and/or data can also be cached in the RAM 912. The systems and methods described herein can be implemented utilizing various commercially available operating systems or combinations of operating systems.

Computer 902 can optionally comprise emulation technologies. For example, a hypervisor (not shown) or other intermediary can emulate a hardware environment for operating system 930, and the emulated hardware can optionally be different from the hardware illustrated in FIG. 9. In such an embodiment, operating system 930 can comprise one virtual machine (VM) of multiple VMs hosted at computer 902. Furthermore, operating system 930 can provide runtime environments, such as the Java runtime environment or the .NET framework, for applications 932. Runtime environments are consistent execution environments that allow applications 932 to run on any operating system that includes the runtime environment. Similarly, operating system 930 can support containers, and applications 932 can be in the form of containers, which are lightweight, standalone, executable packages of software that include, e.g., code, runtime, system tools, system libraries and settings for an application.

Further, computer 902 can be enabled with a security module, such as a trusted processing module (TPM). For instance, with a TPM, boot components hash next in time boot components, and wait for a match of results to secured values, before loading a next boot component. This process can take place at any layer in the code execution stack of computer 902, e.g., applied at the application execution level or at the operating system (OS) kernel level, thereby enabling security at any level of code execution.

A user can enter commands and information into the computer 902 through one or more wired/wireless input devices, e.g., a keyboard 938, a touch screen 940, and a pointing device, such as a mouse 942. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 904 through an input device interface 944 that can be coupled to the system bus 908, but can be connected by other interfaces, such as a parallel port, an IEEE 1394 serial port, a game port, a USB port, an IR interface, a BLUETOOTH® interface, etc.

A monitor 946 or other type of display device can also be connected to the system bus 908 via an interface, such as a video adapter 948. In addition to the monitor 946, a computer typically includes other peripheral output devices (not shown), such as speakers, printers, etc.

The computer 902 can operate in a networked environment using logical connections via wired and/or wireless communications to one or more remote computers, such as a remote computer(s) 950. The remote computer(s) 950 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 952 is illustrated. The logical connections depicted include wired/wireless connectivity to a local area network (LAN) 954 and/or larger networks, e.g., a wide area network (WAN) 956. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 can be connected to the local network 954 through a wired and/or wireless communication network interface or adapter 958. The adapter 958 can facilitate wired or wireless communication to the LAN 954, which can also include a wireless access point (AP) disposed thereon for communicating with the adapter 958 in a wireless mode.

When used in a WAN networking environment, the computer 902 can include a modem 960 or can be connected to a communications server on the WAN 956 via other means for establishing communications over the WAN 956, such as by way of the Internet. The modem 960, which can be internal or external and a wired or wireless device, can be connected to the system bus 908 via the input device interface 944. In a networked environment, program modules depicted relative to the computer 902 or portions thereof, can be stored in the remote memory/storage device 952. It will be appreciated that the network connections shown are examples and other means of establishing a communications link between the computers can be used.

When used in either a LAN or WAN networking environment, the computer 902 can access cloud storage systems or other network-based storage systems in addition to, or in place of, external storage devices 916 as described above. Generally, a connection between the computer 902 and a cloud storage system can be established over a LAN 954 or WAN 956 e.g., by the adapter 958 or modem 960, respectively. Upon connecting the computer 902 to an associated cloud storage system, the external storage interface 926 can, with the aid of the adapter 958 and/or modem 960, manage storage provided by the cloud storage system as it would other types of external storage. For instance, the external storage interface 926 can be configured to provide access to cloud storage sources as if those sources were physically connected to the computer 902.

The computer 902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

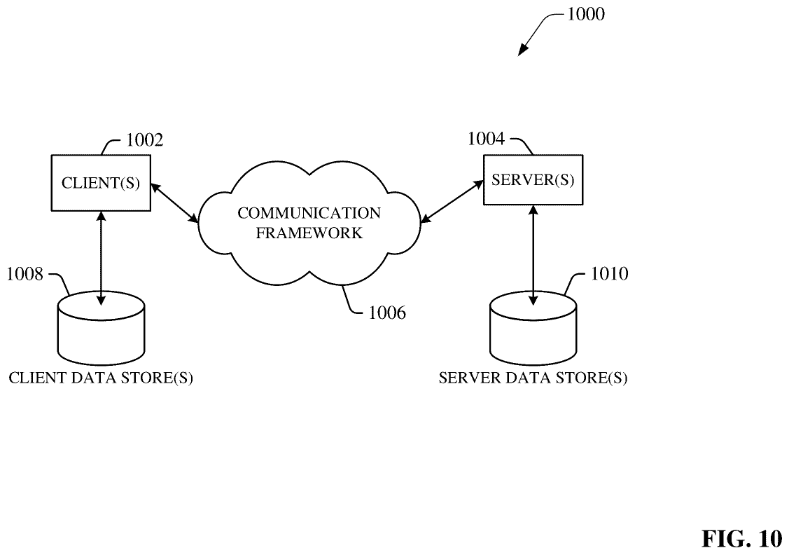

Referring now to FIG. 10, there is illustrated a schematic block diagram of a computing environment 1000 in accordance with this specification. The system 1000 includes one or more client(s) 1002, (e.g., computers, smart phones, tablets, cameras, PDA's). The client(s) 1002 can be hardware and/or software (e.g., threads, processes, computing devices). The client(s) 1002 can house cookie(s) and/or associated contextual information by employing the specification, for example.

The system 1000 also includes one or more server(s) 1004. The server(s) 1004 can also be hardware or hardware in combination with software (e.g., threads, processes, computing devices). The servers 1004 can house threads to perform transformations of media items by employing aspects of this disclosure, for example. One possible communication between a client 1002 and a server 1004 can be in the form of a data packet adapted to be transmitted between two or more computer processes wherein data packets may include coded analyzed headspaces and/or input. The data packet can include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

In one exemplary implementation, a client 1002 can transfer an encoded file, (e.g., encoded media item), to server 1004. Server 1004 can store the file, decode the file, or transmit the file to another client 1002. It is noted that a client 1002 can also transfer uncompressed files to a server 1004 and server 1004 can compress the file and/or transform the file in accordance with this disclosure. Likewise, server 1004 can encode information and transmit the information via communication framework 1006 to one or more clients 1002.

The illustrated aspects of the disclosure may also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
at least one processor; and
at least one memory that stores executable instructions that, when executed by the at least one processor, facilitate performance of operations, comprising:
determining an estimated coherence time for a communicative connection between a user equipment and a base station;
for each channel state information indication of a group of channel state information indications sent from the user equipment to the base station, determining a difference between a current channel state information indication indicative of a current channel state and a previous channel state information indication indicative of a previous channel state; and
in response to a determination that the difference exceeds a defined difference threshold determined based on the estimated coherence time, flagging the current channel state information indication as invalid.

2. The system of claim 1, wherein the estimated coherence time is further determined based on a channel doppler spread of an uplink channel of the communicative connection.

3. The system of claim 1, wherein the estimated coherence time is further determined based on a rate of change of channel state information indications of the group of channel state information indications.

4. The system of claim 1, wherein the estimated coherence time is further determined based on a rate of change of sounding reference signals of a group of sounding reference signals applicable to the communicative connection.

5. The system of claim 1, wherein the difference between the current channel state information indication and the previous channel state information indication is a first difference, and wherein the current channel state information indication is flagged as invalid further based on a comparison of the first difference to a second difference between a current sounding reference signal to a previous sounding reference signal.

6. The system of claim 1, wherein the difference between the current channel state information indication and the previous channel state information indication is determined based on an individual field in response to a determination that a current rank indicator associated with the current channel state information indication and a previous rank indicator associated with the previous channel state information indication are equal or substantially equal.

7. The system of claim 6, wherein the individual field comprises a precoding matrix indicator, a rank indicator, or a channel quality indicator.

8. The system of claim 1, wherein the difference between the current channel state information indication and the previous channel state information indication is determined based on requested overall spectral efficiency in response to a determination that a current rank indicator associated with the current channel state information indication and a previous rank indicator associated with the previous channel state information indication are not equal or substantially equal.

9. The system of claim 1, wherein the operations further comprise:
in response to the current channel state information indication being flagged as invalid, utilizing the previous channel state information indication instead of the current channel state information indication for a base station configuration.

10. The system of claim 1, wherein the operations further comprise:
in response to the current channel state information indication being flagged as invalid, rechecking the current channel state information indication.

11. The system of claim 10, wherein the operations further comprise:
in response to the rechecking the current channel state information indication resulting in the current channel state information indication being determined not to be invalid, removing the flagging.

12. The system of claim 1, wherein the defined difference threshold has been determined based on prior simulations of base station configurations.

13. A non-transitory machine-readable medium, comprising executable instructions that, when executed by at least one processor, facilitate performance of operations, comprising:
determining an estimated coherence time for a communicative connection between a user device and network equipment;
for each channel state information indication of a group of channel state information indications sent from the user device to the network equipment, determining a difference between a current channel state information indication and a previous channel state information indication; and
in response to a determination that the difference exceeds a defined difference threshold determined based on the estimated coherence time, determining that the current channel state information indication is incorrect.

14. The non-transitory machine-readable medium of claim 13, wherein the estimated coherence time is further determined based on a channel doppler spread of an uplink channel of the communicative connection.

15. The non-transitory machine-readable medium of claim 13, wherein the estimated coherence time is further determined based on a rate of change of channel state information indications of the group of channel state information indications.

16. The non-transitory machine-readable medium of claim 13, wherein the estimated coherence time is further determined based on a rate of change of sounding reference signals of a group of sounding reference signals applicable to the communicative connection.

17. The non-transitory machine-readable medium of claim 13, wherein the difference between the current channel state information indication and the previous channel state information indication is a first difference, and wherein the current channel state information indication is determined to be incorrect further based on a comparison of the first difference to a second difference between a current sounding reference signal to a previous sounding reference signal.

18. A method, comprising:
determining, by a device comprising at least one processor, an estimated coherence time for a communicative connection between a mobile device and an access point;
for each channel state information indication of a group of channel state information indications sent from the mobile device to the access point, determining, by the device, a difference between a current channel state information indication and a previous channel state information indication; and
in response to a determination that the difference exceeds a defined difference threshold determined based on the estimated coherence time, tagging, by the device, the current channel state information indication as inaccurate.

19. The method of claim 18, wherein the difference between the current channel state information indication and the previous channel state information indication is determined based on an individual field in response to a determination that a current rank indicator associated with the current channel state information indication and a previous rank indicator associated with the previous channel state information indication are equal or substantially equal.

20. The method of claim 19, wherein the individual field comprises a precoding matrix indicator, a rank indicator, or a channel quality indicator.
